(19) United States
(12) Patent Application Publication
(10) Pub. No.: US 2023/0334902 A1
(43) Pub. Date: Oct. 19, 2023

(54) METHOD AND SYSTEM FOR TRAINING A MACHINE LEARNING MODEL FOR FACE RECOGNITION

(71) Applicant: VINAI ARTIFICIAL INTELLIGENCE APPLICATION AND RESEARCH JOINT STOCK COMPANY, Ha Noi (VN)

(72) Inventors: Duc Toan BUI, Ha Noi (VN); Van Tuong NGUYEN, Ha Noi (VN); The De VU, Ha Noi (VN); Viet Thanh Dat NGUYEN, Ha Noi (VN); Hai Hung BUI, Ha Noi (VN)

(21) Appl. No.: 17/971,754

(22) Filed: Oct. 24, 2022

(30) Foreign Application Priority Data
Apr. 19, 2022 (VN) 1-2022-02443

(51) Int. Cl. G06V 40/16; G06V 10/764

(52) U.S. Cl. CPC G06V 40/168; G06V 10/764

(57) ABSTRACT

The present invention relates to a method and a system for training a machine learning model for face recognition. The method comprising generating a training dataset; providing a teacher model that comprises a teacher backbone and a teacher head; iteratively training the teacher backbone and the teacher head using the training dataset; setting the machine learning model to include a lightweight backbone and a lightweight head; copying trained parameters of the trained teacher head to the lightweight head; and iteratively training the lightweight backbone using the training dataset.

### CROSS-REFERENCE TO RELATED APPLICATIONS

This application claims priority to Vietnamese Patent Application No. 1-2022-02443 filed on Apr. 19, 2022, which is incorporated herein by reference.

### TECHNICAL FIELD

The present invention generally relates to a method and system for training a machine learning model for face recognition.

### BACKGROUND

Nowadays, the deep-learning approach becomes more popular for computer vision task; however, it requires a lot of computing resource that is expensive. Thus, it is difficult to apply these deep learning models on a mobile device or embedded device with cheap price.

Face recognition is a critical component of Driver Monitoring System of a vehicle that is used for recognizing the driver and application on auto-unlock the vehicle.

Hence, developing a lightweight model that is able to run the face recognition on a mobile device or an embedded device such as Driver Monitoring System is a crucial task.

### SUMMARY

The invention has been made to solve the above-mentioned problems. An object of the invention is to provide a method and system for training a machine learning model that is able to run the face recognition on a mobile device or an embedded device such as Driver Monitoring System of a vehicle.

Problems to be solved in the embodiments are not limited thereto and include the following technical solutions and also objectives or effects understandable from the embodiments.

According to a first aspect of the invention, there is provided a method for training a machine learning model for face recognition, the method comprising:
generating a training dataset that comprises a plurality of color images and a plurality of infrared images;
providing a teacher model that comprises a teacher backbone and a teacher head;
iteratively training the teacher backbone and the teacher head using the training dataset by at least:
   processing a training image in the training dataset using the teacher backbone to generate a teacher feature map;
   processing the teacher feature map using the teacher head to generate a predicted face;
   minimizing a teacher model loss that measures distance between the predicted face and a face ground-truth in the training image;
setting the machine learning model to include a lightweight backbone and a lightweight head, wherein the architecture of the lightweight head is the same as the architecture of the teacher head;
copying trained parameters of the trained teacher head to the lightweight head;
iteratively training the lightweight backbone using the training dataset by at least:
   processing a training image in the training dataset using the trained teacher model to generate a teacher model specific face;
   processing the training image using the lightweight backbone to generate a lightweight backbone feature map;
   processing the lightweight backbone feature map using the lightweight head to generate a lightweight model specific predicted face; and
   minimizing a transfer loss that measures distance between the teacher model specific face and the lightweight model specific predicted face.

According to a second aspect of the invention, there is provided a system for training a machine learning model for face recognition, the system comprises one or more computers and one or more storage devices storing instructions that, when executed by the one or more computers, cause the one or more computers to perform the method according to the first aspect of the invention.

### BRIEF DESCRIPTION OF THE DRAWINGS

The above and other objects, features, and advantages of the present invention will become more apparent to those of ordinary skill in the art by describing in detail exemplary embodiments thereof with reference to the attached drawings, in which:

FIG. 1 is a block diagram showing an example system for training a machine learning model for face recognition; and

FIG. 2 is a flow diagram of an example process for training a machine learning model for face recognition using the example system of FIG. 1.

### DETAILED DESCRIPTION

While the invention may have various modifications and alternative forms, specific embodiments thereof are shown by way of example in the drawings and will be described herein in detail. However, there is no intent to limit the invention to the particular forms disclosed. On the contrary, the invention is to cover all modifications, equivalents, and alternatives falling within the spirit and scope of the appended claims.

It should be understood that, although the terms “first,” “second,” and the like may be used herein to describe various elements, the elements are not limited by the terms. The terms are only used to distinguish one element from another element. For example, a first element could be termed a second element, and, similarly, a second element could be termed a first element without departing from the scope of the invention. As used herein, the term “and/or” includes any and all combinations of one or more of the associated listed items.

The terminology used herein is for the purpose of describing particular embodiments only and is not intended to be limiting to the invention. As used herein, the singular forms “a,” “an,” “another,” and “the” are intended to also include the plural forms, unless the context clearly indicates otherwise. It should be further understood that the terms “comprise,” “comprising,” “include,” and/or “including,” when used herein, specify the presence of stated features, integers, steps, operations, elements, parts, or combinations thereof, but do not preclude the presence or addition of one or more other features, integers, steps, operations, elements, parts, or combinations thereof.

Unless otherwise defined, all terms including technical and scientific terms used herein have the same meaning as commonly understood by one of ordinary skill in the art to which this invention belongs. It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

Hereinafter, embodiments will be described in detail with reference to the accompanying drawings, the same or corresponding components are denoted by the same reference numerals regardless of reference numbers, and thus the description thereof will not be repeated.

And throughout the detailed description and claims of the present disclosure, the term “training/trained” or “learning/learned” refers to performing machine learning through computing in accordance with a procedure. It will be appreciated by those skilled in the art that it is not intended to refer to a mental function such as human educational activity.

As used herein, a model is trained to output a predetermined output with respect to a predetermined input, and may include, for example, neural networks. A neural network refers to a recognition model that simulates a computation capability of a biological system using a large number of artificial neurons being connected to each other through edges.

The neural network uses artificial neurons configured by simplifying functions of biological neurons, and the artificial neurons may be connected to each other through edges having connection weights. The connection weights, parameters of the neural network, are predetermined values of the edges, and may also be referred to as connection strengths. The neural network may perform a cognitive function or a learning process of a human brain through the artificial neurons. The artificial neurons may also be referred to as nodes.

A neural network may include a plurality of layers. For example, the neural network may include an input layer, a hidden layer, and an output layer. The input layer may receive an input to be used to perform training and transmit the input to the hidden layer, and the output layer may generate an output of the neural network based on signals received from nodes of the hidden layer. The hidden layer may be disposed between the input layer and the output layer. The hidden layer may change training data received from the input layer to an easily predictable value. Nodes included in the input layer and the hidden layer may be connected to each other through edges having connection weights, and nodes included in the hidden layer and the output layer may also be connected to each other through edges having connection weights. The input layer, the hidden layer, and the output layer may respectively include a plurality of nodes.

Hereinafter, training a neural network refers to training parameters of the neural network. Further, a trained neural network refers to a neural network to which the trained parameters are applied.

Basically, the neural network may be trained through supervised learning or unsupervised learning. Supervised learning refers to a method of providing input data and label corresponding thereto to the neural network, while in unsupervised learning, the input data provided to the neural network does not contain label.

A vehicle as described in this disclosure may include, for example, a car or a motorcycle, or any suitable motorized vehicle. Hereinafter, a car will be described as an example.

A vehicle as described in this disclosure may be powered by any suitable power source, and may be, for example, an internal combustion engine vehicle including an engine as a power source, a hybrid vehicle including both an engine and an electric motor as a power source, and/or an electric vehicle including an electric motor as a power source.

A camera as described in this disclosure may include, but is not limited to, various optical and non-optical imaging devices, like a RGB camera, stereovision camera or any device whose output data may be used in perceiving the environment. Other imaging devices capable of observing objects may also be used, such as ultrasonic sensors, sonar, LIDAR, and LADAR devices. Thus, various combinations of one or more cameras and sensors may be used.

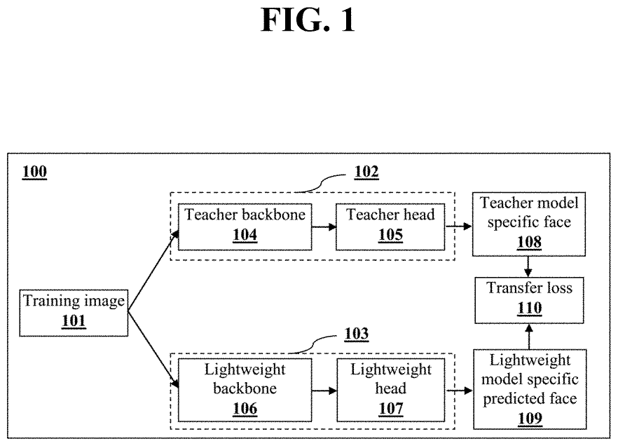

FIG. 1 is the block diagram showing an example system for training a machine learning model for face recognition (hereinafter, the system 100). The system 100 is an example of a system implemented as computer programs on one or more computers in one or more locations in which the systems, components, and techniques described below are implemented. The trained machine learning model, when being implemented on a mobile device or an embedded device such as Driver Monitoring System of a vehicle, is capable of recognizing a face from an image.

The system 100 comprises a teacher model 102 and the machine learning model 103. To train the machine learning model 103, the system 100 first trains the teacher model 102 using a training dataset.

The training dataset comprises a plurality of color images and a plurality of infrared images. According to a preferred embodiment, the training dataset is composed of two components. The first component is a large-scale face recognition dataset crawled from the internet, for example, MS-Celeb-1M. The second component is an in house dataset of 300 subjects collected by infrared cameras and RGB cameras; each subject has 200 images (including color images and infrared images). The training dataset may be pre-processed for the training step. In particular, the images of the first component and the color images of the second components are converted into gray scale images. Further, the images in the training dataset are aligned and cropped to a predetermined size. In one example, the predetermined size is set to 112×112.

The teacher model comprises a teacher backbone 104 and a teacher head 105. According to the preferred embodiment, IR-101 [1] backbone and Arcface head [1] are used to implement the teacher backbone 104 and the teacher head 105, respectively. The teacher backbone 104 and the teacher head 105 are iteratively trained on the training dataset.

In particular, the teacher backbone 104 processes a training image in the training dataset to generate a teacher feature map.

Next, the teacher head 105 process the teacher feature map to generate a predicted face.

Then, the system 100 minimizes a teacher model loss that measures distance between the predicted face and a face ground-truth in the training image.

According to the preferred embodiment, the teacher model is trained with the momentum of 0.9 and the weight decay of 0.0005. The learning rate starts from 0.1 and is divided by 10, 20, 30 epochs and finishes at 35 epochs.

After being trained, the teacher model is used to transfer knowledge thereof to the machine learning model 103. According to the preferred embodiment, the machine learning model 103 is a lightweight model that comprises a lightweight backbone 106 and a lightweight head 107. According to the preferred embodiment, the architecture of the lightweight head 107 is the same as the architecture of the teacher head 105. On the other hand, the number of parameters of the lightweight backbone 106 is significantly lower than the number of parameters of the teacher backbone 104.

Since the architecture of the lightweight head 107 is the same with the architecture of the teacher head 105, the system 100 copies trained parameters of the trained teacher head 105 to the lightweight head 107 such that the lightweight head 107 have the same face recognition ability of the trained teacher head 105.

According to the preferred embodiment, the lightweight backbone 106 is based on Mobilenet V2 that is an efficient convolutional neural network design for resource-constrained device, mobile device and embedded device-based computer vision applications. A first key building block of Mobilenet V2 is depth-wise separable convolutions, which factorize a conventional, full convolutional operation into a first depth-wise convolution to filter the input channels, and a second point-wise convolution to combine outputs of the depth-wise network layer to build a feature map. Depth-wise separable convolutions trade significant improvements in computational efficiency for a small reduction in accuracy. A second key building block of Mobilenet V2 is inverted residuals connecting linear bottleneck layers between individual depth-wise separable convolutional layers, which also tradeoff computation and accuracy. Linear bottleneck layers reduce the dimensionality of the input, while inverted residuals use shortcut connections between the bottlenecks to enable faster training and better accuracy.

The system 100 iteratively trains the lightweight backbone 106 on the training dataset.

In particular, the trained teacher model 102 processes a training image 101 in the training dataset to generate a teacher model specific face 108.

The lightweight backbone 106 processes the training image 101 to generate a lightweight backbone feature map (not shown). Next, the lightweight head 107 processes the lightweight backbone feature map based on the trained parameters which are copied from the trained teacher head 105 to generate a lightweight model specific predicted face 109.

Then, the system 100 minimizes a transfer loss 110 that measures distance between the teacher model specific face 108 and the lightweight model specific predicted face 109. According to the preferred embodiment, the transfer loss is a L₂ loss.

Accordingly, after being trained, the machine learning model with two light weight components (i.e., the lightweight backbone 106 and the lightweight head 107) is implemented on a mobile device or an embedded device to perform a face recognition task on a color image or an infrared image.

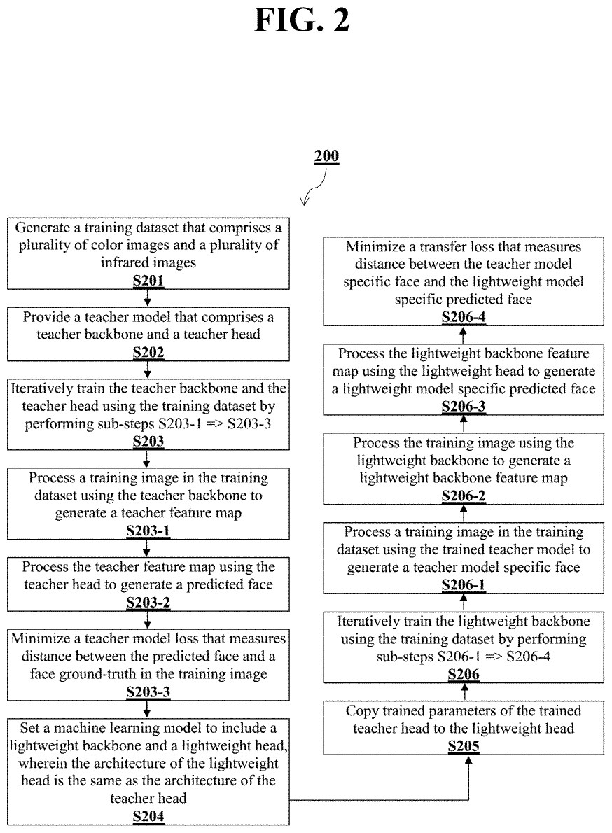

FIG. 2 is a flow diagram of an example process 200 for training a machine learning model for face recognition. For convenience, the process 200 will be described as being performed by a system of one or more computers located in one or more locations. For example, a system for training a machine learning model for face recognition, e.g., the system 100 for training a machine learning model for face recognition (hereinafter referred to as “the system”) of FIG. 1, appropriately programmed, can perform the process 200.

In step S201, the system generates a training dataset that comprises a plurality of color images and a plurality of infrared images. According to a preferred embodiment, the generating of the training dataset further comprises (i) converting the plurality of color images into gray scale images; and (ii) aligning and cropping images in the training dataset to a predetermining size.

In step S202, the system provides a teacher model (for example, the teacher model 102 of FIG. 1) that comprises a teacher backbone (for example, the teacher backbone 104 of FIG. 1) and a teacher head (for example, the teacher head 105 of FIG. 1).

In step S203, the system iteratively trains the teacher backbone and the teacher head using the training dataset by performing sub-steps S203-1 to S203-3.

In step S203-1, the system processes a training image in the training dataset using the teacher backbone to generate a teacher feature map.

In step S203-2, the system processes the teacher feature map using the teacher head to generate a predicted face.

In step S203-3, the system minimizes a teacher model loss that measures distance between the predicted face and a face ground-truth in the training image.

In step S204, the system sets the machine learning model (for example, the machine learning model 103 of FIG. 1) to include a lightweight backbone and a lightweight head, wherein the architecture of the lightweight head is the same as the architecture of the teacher head.

In step S205, the system copies trained parameters of the trained teacher head to the lightweight head.

In step S206, the system iteratively trains the lightweight backbone using the training dataset by performing sub-steps S206-1=>S206-4.

In sub-step S206-1, the system processes a training image (for example, the training image 101 of FIG. 1) in the training dataset using the trained teacher model to generate a teacher model specific face (for example, the teacher model specific face 108 of FIG. 1).

In sub-step S206-2, the system processes the training image using the lightweight backbone to generate a lightweight backbone feature map.

In sub-step S206-3, the system processes the lightweight backbone feature map using the lightweight head to generate a lightweight model specific predicted face (for example, the lightweight model specific predicted face 109 of FIG. 1).

In sub-step S206-4, the system minimizes a transfer loss (for example, the transfer loss 110 of FIG. 1) that measures distance between the teacher model specific face and the lightweight model specific predicted face.

According to the preferred embodiment, the transfer loss is a L₂ loss and the lightweight backbone is based on Mobilenet V2.

The process 200 further comprises step of implementing the trained machine learning model on a mobile device or an embedded device (e.g., a driver monitoring system of a vehicle) to perform face recognition on a color image or an infrared image.

For a system of one or more computers to be configured to perform particular operations or actions means that the system has installed on it software, firmware, hardware, or a combination of them that in operation cause the system to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a relationship graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method for training a machine learning model for face recognition, the method comprising:
generating a training dataset that comprises a plurality of color images and a plurality of infrared images;
providing a teacher model that comprises a teacher backbone and a teacher head;
iteratively training the teacher backbone and the teacher head using the training dataset by at least:
processing a training image in the training dataset using the teacher backbone to generate a teacher feature map;
processing the teacher feature map using the teacher head to generate a predicted face;
minimizing a teacher model loss that measures distance between the predicted face and a face ground-truth in the training image;
setting the machine learning model to include a lightweight backbone and a lightweight head, wherein the architecture of the lightweight head is the same as the architecture of the teacher head;
copying trained parameters of the trained teacher head to the lightweight head; and
iteratively training the lightweight backbone using the training dataset by at least:
processing a training image in the training dataset using the trained teacher model to generate a teacher model specific face;
processing the training image using the lightweight backbone to generate a lightweight backbone feature map;
processing the lightweight backbone feature map using the lightweight head to generate a lightweight model specific predicted face; and
minimizing a transfer loss that measures distance between the teacher model specific face and the lightweight model specific predicted face.

2. The method of claim 1, further comprising implementing the trained machine learning model on a mobile device or an embedded device to perform face recognition on an input image.

3. The method of claim 2, wherein the input image is an infrared image.

4. The method of claim 3, wherein the embedded device is a driver monitoring system of a vehicle.

5. The method of claim 4, wherein the generating of the training dataset further comprises:
converting the plurality of color images into gray scale images; and
aligning and cropping images in the training dataset to a predetermining size.

6. The method of claim 5, wherein the transfer loss is a L₂ loss.

7. The method of claim 6, wherein the lightweight backbone is based on Mobilenet V2.

8. A system for training a machine learning model for face recognition, the system comprising one or more computers and one or more storage devices storing instructions that, when executed by the one or more computers, cause the one or more computers to perform operations comprising:
generating a training dataset that comprises a plurality of color images and a plurality of infrared images;
providing a teacher model that comprises a teacher backbone and a teacher head;
iteratively training the teacher backbone and the teacher head using the training dataset by at least:
processing a training image in the training dataset using the teacher backbone to generate a teacher feature map;
processing the teacher feature map using the teacher head to generate a predicted face;
minimizing a teacher model loss that measures distance between the predicted face and a face ground-truth in the training image;
setting the machine learning model to include a lightweight backbone and a lightweight head, wherein the architecture of the lightweight head is the same as the architecture of the teacher head;
copying trained parameters of the trained teacher head to the lightweight head; and
iteratively training the lightweight backbone using the training dataset by at least:
processing a training image in the training dataset using the trained teacher model to generate a teacher model specific face;
processing the training image using the lightweight backbone to generate a lightweight backbone feature map;
processing the lightweight backbone feature map using the lightweight head to generate a lightweight model specific predicted face; and
minimizing a transfer loss that measures distance between the teacher model specific face and the lightweight model specific predicted face.
